(19) United States
(12) Patent Application Publication
(10) Pub. No.: US 2010/0090995 A1
(43) Pub. Date: Apr. 15, 2010

(54) DISPLAY APPARATUS HAVING LARGER DISPLAY AREA

(76) Inventors: Chae-Woo CHUNG, Cheonan-si (KR); Jae-Hyun Cho, Seoul (KR); Jeong-Uk Heo, Sungnam-si (KR); Sun-Kyu Son, Suwon-si (KR); Dong-Hyeon Ki, Cheonan-si (KR)

Correspondence Address: Innovation Counsel LLP, 21771 Stevens Creek Blvd, Ste. 200A, Cupertino, CA, 95014, US

(21) Appl. No.: 12/577,614

(22) Filed: Oct. 12, 2009

(30) Foreign Application Priority Data
Oct. 13, 2008 (KR) 10-2008-0100211

(51) Int. Cl. G09G 5/00; G09G 3/20

(52) U.S. Cl. 345/205; 345/55

(57) ABSTRACT

A display apparatus and a multi-display apparatus having larger display areas. The display apparatus includes a first insulating substrate, as well as a plurality of gate lines and a plurality of data lines on the first insulating substrate, where the plurality of gate lines is arranged to intersect the plurality of data lines. A plurality of storage electrode lines is arranged substantially parallel to the plurality of gate lines. A gate drive chip is mounted off of the first insulating substrate and electrically connected to the plurality of gate lines and the plurality of storage electrode lines. The gate drive chip is configured to apply a gate voltage to the gate lines and a storage voltage to the storage electrode lines.

### CROSS-REFERENCE TO RELATED APPLICATION

This application claims priority to Korean Patent Application No. 10-2008-0100211 filed on Oct. 13, 2008 in the Korean Intellectual Property Office, the disclosure of which is incorporated herein by reference in its entirety.

### BACKGROUND OF THE INVENTION

1. Field of the Invention

The present invention relates to flat panel displays, and more particularly, to a display apparatus having a larger display area.

2. Description of the Related Art

Market demand for display apparatuses with large-screen size and slim profile is increasing. To overcome the disadvantages of the conventional CRTs, there is increasing demand for flat panel display devices of various technologies, such as PDP (Plasma Display Panel) devices, PALC (Plasma Address Liquid Crystal display panel) devices, LCD (Liquid Crystal Display) devices, OLED (Organic Light Emitting Diode) devices, and the like.

Of the above technologies, LCDs in particular have some notable advantages, such as small size, light weight, and low power consumption. LCDs are thus currently used in a wide variety of applications, including use in fields such as the computer industry, the electronic industry, the information telecommunication industry, and the like. The LCD typically includes a liquid crystal panel assembly with a liquid crystal panel displaying image information, a backlight assembly that includes a light emitter for emitting light and a light guiding plate for guiding light toward the liquid crystal panel, and a receiving container that receives/holds the liquid crystal panel and the backlight assembly.

Recently, in a display apparatus and multi-display apparatus having a plurality of display apparatuses connected with each other, increasing attention has been given to reducing the non-display area (i.e., increasing the size of the display area) for better display of image information. This trend highlights the current increasing desire for displays with reduced non-display areas, i.e. for panels with larger display areas. This trend is particularly evident in applications that utilize multi-display apparatuses. More specifically, the larger the display area of each individual display apparatus, the more seamless the overall image of the multi-display apparatus appears. Accordingly, in many applications, and especially in applications such as multi-display apparatuses, it is desirable to increase the size of display areas in flat panel displays.

### SUMMARY OF THE INVENTION

The present invention provides a display apparatus which can reduce a bezel width corresponding to a peripheral area.

The present invention also provides a multi-display apparatus, which allows a viewer to see the entire screen more seamlessly by reducing a peripheral area.

The above and other objects of the present invention will be described in or be apparent from the following description of the preferred embodiments.

According to an aspect of the present invention, there is provided a display apparatus comprising a first insulating substrate, as well as a plurality of gate lines and a plurality of data lines on the first insulating substrate, where the plurality of gate lines is arranged to intersect the plurality of data lines. Also included is a plurality of storage electrode lines arranged substantially parallel to the plurality of gate lines, and a gate drive chip mounted off of the first insulating substrate and electrically connected to the plurality of gate lines and the plurality of storage electrode lines. The gate drive chip configured to apply a gate voltage to the gate lines and a storage voltage to the storage electrode lines.

According to another aspect of the present invention, there is provided a multi-display apparatus comprising: a plurality of display units, each display unit including a first insulating substrate, a plurality of gate lines and a plurality of data lines arranged to intersect one another on the first insulating substrate, a plurality of storage electrode lines arranged substantially parallel to the plurality of gate lines, and a gate drive chip mounted off of the first insulating substrate and electrically connected to the plurality of gate lines and the plurality of storage electrode lines. The gate drive chip is configured to apply a gate voltage to the gate lines and a storage voltage to the storage electrode lines. Also included is a fixing unit combining the plurality of display units to form a matrix.

### BRIEF DESCRIPTION OF THE DRAWINGS

The above and other features and advantages of the present invention will become more apparent by describing in detail preferred embodiments thereof with reference to the attached drawings in which:

FIG. 1A is a perspective view of a liquid crystal panel assembly for a display apparatus according to an embodiment of the present invention;

FIGS. 1B and 1C illustrate modified examples of the liquid crystal panel assembly shown in FIG. 1A;

FIG. 2 is a plan view of the liquid crystal panel assembly shown in FIG. 1A;

FIG. 3A is an enlarged view of a region A in a lower substrate shown in FIG. 2;

FIG. 3B is a cross-sectional view taken along line I-I′ of FIG. 3A;

FIG. 4A is an enlarged view of a region B in the lower substrate shown in FIG. 2;

FIG. 4B is a cross-sectional view taken along line II-II′ of FIG. 4A;

FIG. 5A illustrates a modified example of FIG. 4A;

FIG. 5B illustrates a modified example of FIG. 4B;

FIG. 6A is an exploded perspective view of a liquid crystal display (LCD) module according to an embodiment of the present invention;

FIG. 6B is an assembled perspective view of the LCD module of FIG. 6A;

FIG. 7A is a cross-sectional view of the LCD module taken along line B-B′ of FIG. 6B;

FIG. 7B is a cross-sectional view of the LCD module taken along line A-A′ of FIG. 6B; and

FIG. 8 is a perspective view of a multi-display apparatus according to an embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Exemplary embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. Like reference numerals refer to like elements throughout the specification.

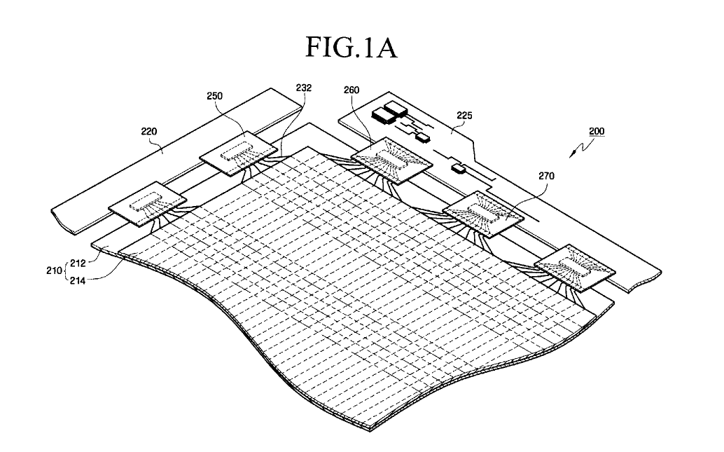

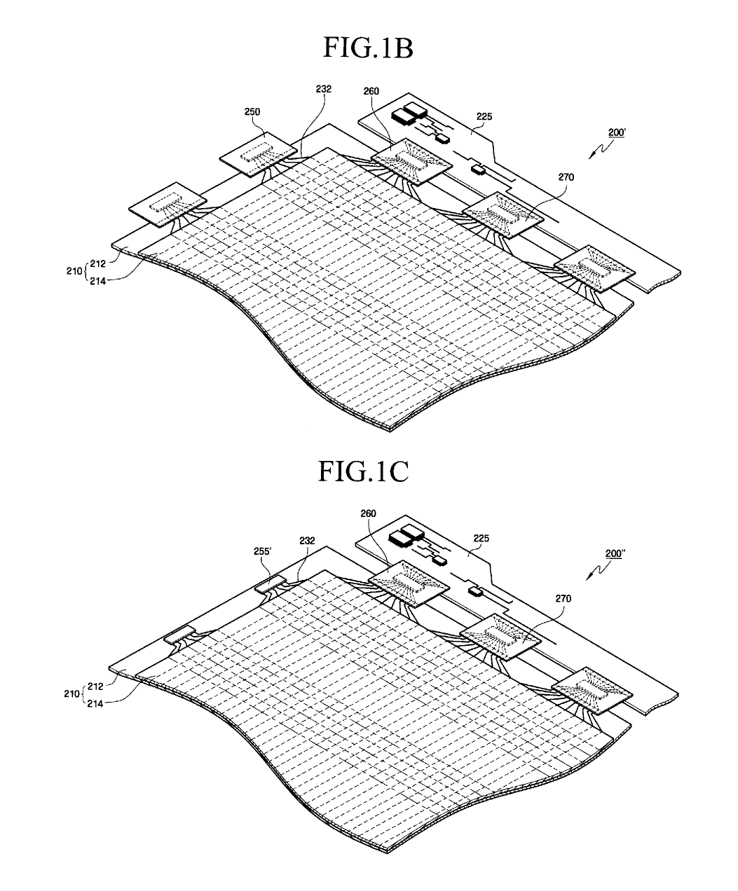

FIG. 1A is a perspective view of a liquid crystal panel assembly 200 in a display apparatus according to an embodiment of the present invention. FIGS. 1B and 1C illustrate modified examples of the liquid crystal panel assembly 200 of FIG. 1A. Referring to FIG. 1A, the liquid crystal panel assembly 200 includes a liquid crystal panel 210, first flexible films 250, second flexible films 260 and 270, and first and second printed circuit boards (PCBs) 220 and 225.

The liquid display panel 210 includes a lower substrate 212 and an upper substrate 214. The lower substrate 212 has storage electrode lines 235, data lines 234, thin film transistors (TFTs), and pixel electrodes. The upper substrate 214 has black matrixes, color filters, and a common electrode. The upper substrate 214 is smaller than the lower substrate 212, and the upper substrate 214 is disposed adjacent to, and facing, the lower substrate 212. A liquid crystal layer (not shown) is interposed between the lower substrate 212 and the upper substrate 214.

Each of the first flexible films 250 is connected to a plurality of gate lines 232 and a plurality of storage electrode lines 235 formed on a lower substrate 212. In this embodiment, the storage electrode lines 235 are arranged parallel to the gate lines 232, and are connected to a gate drive chip 255 mounted on the first flexible film 250. Since the storage electrode lines 235 are connected to the gate drive chip 255 in order to deliver storage voltages, the liquid crystal panel assembly 200 eliminates the need for a separate storage electrode supply line on an edge of the lower substrate 212, thereby allowing for reduced non-display area. More specifically, the gate drive chip 255 is mounted off of the substrates 212, 214 and on the flexible film 250. As the gate drive chip 255 is not mounted on either substrate 212, 214, its footprint does not occupy the non-display area of either substrate 212, 214, thus reducing the overall footprint of the non-display area.

The second flexible films 260 and 270 are connected to a plurality of data lines 234 formed on the lower substrate 212, and have respective data drive chips 275 mounted thereon. The data drive chips 275 transmit data driving signals to the plurality of data lines 234.

The first PCB 220 has a plurality of drive components for applying a gate drive voltage. In this embodiment, the drive components include semiconductor chips designed using a one-chip technology. The first PCB 220 is connected to the lower substrate 212 by the first flexible film 250.

Meanwhile, the first PCB 220 applies storage voltages to the plurality of storage electrode lines 235 via the first flexible films 250. For example, storage voltages may be applied to the respective storage electrode lines 235 through the gate drive chips 255 mounted on the first flexible films 250.

The second PCB 225 has a plurality of drive components for applying data voltages, and is connected to the lower substrate 212 by the second flexible films 260 and 270. The second flexible films 260 and 270 include the respective data drive chips 275 that apply data voltages to the plurality of data lines 234.

The gate lines 232 are equally spaced in the display area DA on which images are actually displayed, and are also tapered toward fan-out regions to form clusters facilitating coupling with the first flexible film 220. The fan-out regions are located at edges of the display area DA, and are connected to the first flexible film 250 in a non-display area NA on which an image is not displayed.

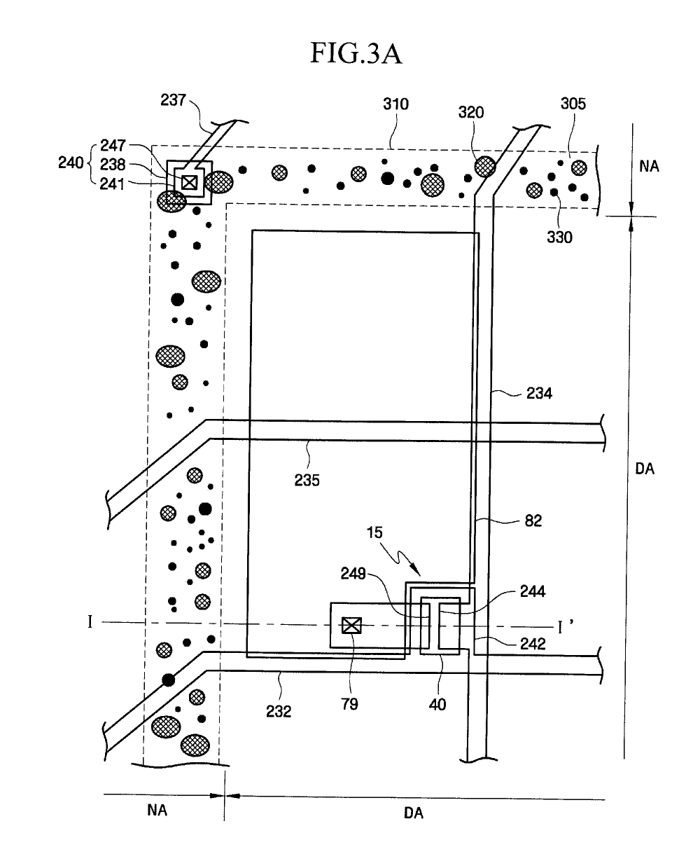

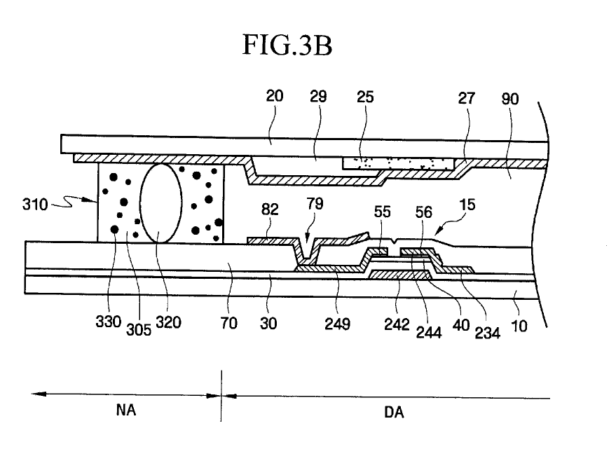

The storage electrode lines 235 are arranged between the gate lines 232 (i.e., storage electrode lines 235 alternate with gate lines 232) and are substantially equally spaced on the lower substrate 212, so as to be approximately parallel with the plurality of gate lines 232. The storage electrode lines 235 and the gate lines 232 may be formed by the same process. A pixel electrode and a gate insulating film overlap the plurality of storage electrode lines 235 arranged on the lower substrate 212, so as to form a storage capacitor. A storage voltage applied to the storage electrode line 235 is adjusted to maintain a substantially constant voltage supplied to the pixel electrode (82 in FIG. 3A). As above, the gate lines 232 are arranged in alternating fashion with the storage electrode lines 235.

The data lines 234 are equally spaced in display area DA where images are actually displayed, and are tapered toward fan-out regions to form clusters facilitating coupling with the second flexible films 260 and 270. The fan-out region is located at an edge of the display area DA, and connected to the second flexible films 260 and 270 in the non-display area NA where images are not displayed.

Common contacts 240 are arranged near a top or bottom edge of the lower substrate 212 at predetermined intervals, and apply a common power voltage to common electrodes on an upper substrate 214. Each of the common contacts 240 is connected to a common electrode line 237, receives a common power signal input from the data drive chip 275, and thus transmits a common voltage to the upper substrate 214.

The first flexible film 250 may include gate and storage electrode wire patterns formed on the base film, as well as gate drive chips 255. The gate drive chips 255 are semiconductor chips mounted on the first flexible film 250 together with the wire patterns by, for example, a TAB (Tape Automated Bonding) technique. The gate drive chips 255 are electrically connected to the gate lines 232 and the storage electrode lines 235 to apply a gate voltage and a storage voltage to the gate lines 232 and the storage electrode lines 235, respectively. The first flexible film 250 transmits gate driving signals output from the first PCB 220 to the TFTs of the lower substrate 212.

Here, the second flexible films 260 and 270 may include wire patterns formed on the base film, and data drive chips 275 electrically connected to the wire patterns. The data drive chips 275 are semiconductor chips mounted on the first flexible film 250 together with the wire patterns by, for example, a TAB (Tape Automated Bonding) technique. In addition, the second flexible films 260 and 270 transmit data driving signals output from the second PCB 225 to the TFTs of the lower substrate 212.

As described above, according to the present embodiment, the gate lines 232 and storage electrode lines 235 are connected directly to the first flexible film 250, so that the first PCB 220 can apply storage voltages directly to the storage electrode lines 235 via the first flexible film 250. This eliminates the need for the conventional contact hole and/or wiring line at an outer perimeter of the lower substrate 212, which is the common approach for applying a storage voltage to the storage electrode line 235. Eliminating these contact holes and/or wiring lines allows for reduction in the size of the outer perimeter of the lower substrate 212, thereby allowing for a reduction in the size of the non-display area NA. Further, by adjusting the magnitude of a storage voltage being applied to each of the plurality of storage electrode lines 235, it is possible to control a voltage supplied to the pixel electrode 82.

Referring to FIG. 1B, a liquid crystal panel assembly 200′ according to a further embodiment of the liquid crystal panel assembly 200 includes gate drive chips 255 mounted on the first flexible films 250. Unlike the liquid crystal panel assembly 200, the liquid crystal panel assembly 200′ does not include a PCB. In this case, each of the gate drive chips 255 on the first flexible film 250 is connected directly to the gate lines 232 and the storage electrode lines 235, so as to apply a gate voltage and a storage voltage, respectively.

Referring to FIG. 1C, a liquid crystal panel assembly 200″ according to still further embodiment of the liquid crystal panel assembly 200 includes gate drive chips 255′ mounted on the lower substrate 212. The gate drive chips 255′ are electrically connected to the gate lines 232 and the storage electrode lines 235 so as to apply a gate voltage and a storage voltage, respectively.

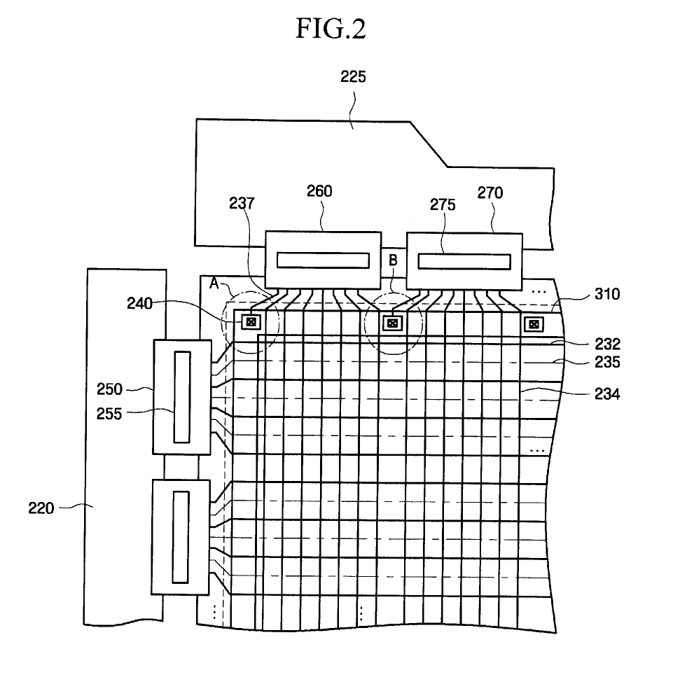

Connection of a storage electrode line and application of a common power voltage via a common contact within a seal line in a display apparatus according to embodiments of the present invention will be described in more detail with reference to FIGS. 2 through 5B.

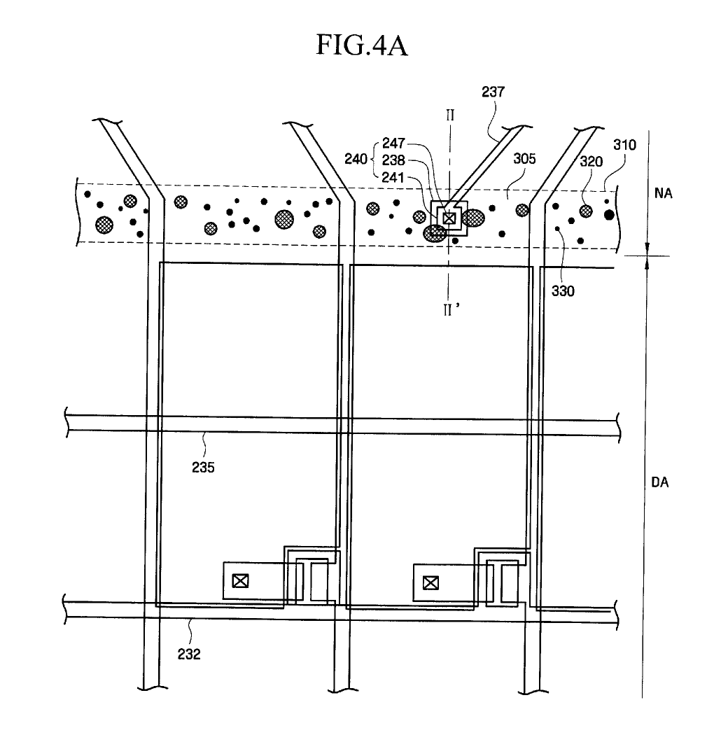

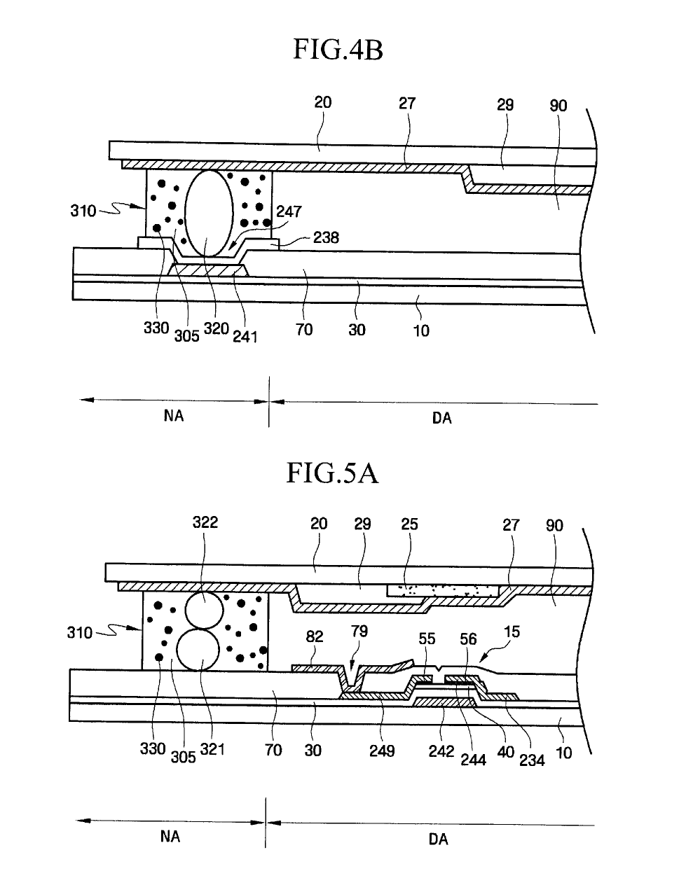

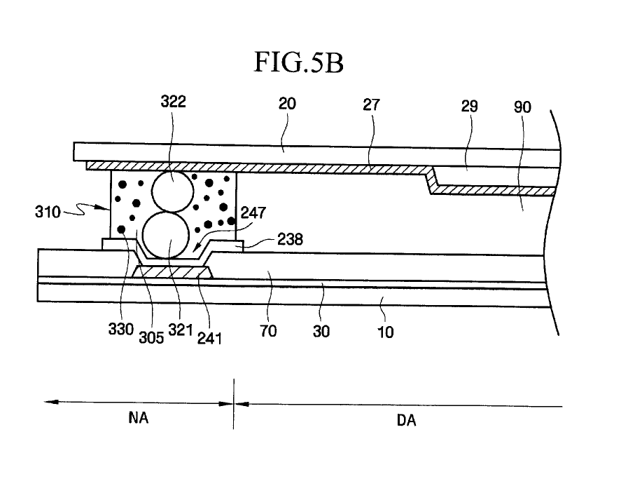

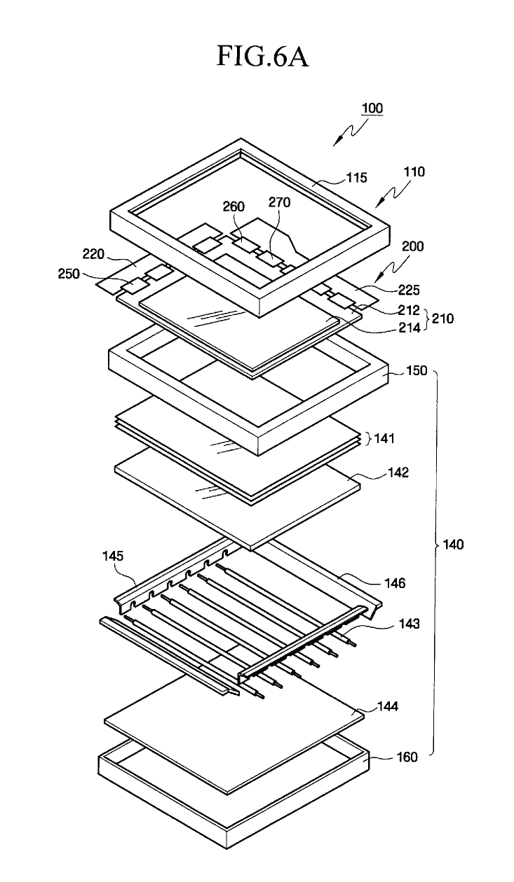

FIG. 2 is a plan view of the liquid crystal panel assembly shown in FIG. 1A. FIG. 3A is an enlarged view of a region A in a lower substrate 212 shown in FIG. 2, and FIG. 3B is a cross-sectional view taken along line I-I′ of FIG. 3A. FIG. 4A is an enlarged view of a region B in the lower substrate 212 shown in FIG. 2, and FIG. 4B is a cross-sectional view taken along line of FIG. 4A. FIGS. 5A and 5B respectively illustrate modified examples of FIGS. 4A and 4B.

Referring to FIG. 2, the lower substrate 212 includes a plurality of thin-film transistors (TFTs) arranged in an array, as well as a plurality of pixel electrodes. A plurality of data lines 234 are arranged to intersect a plurality of gate lines 232. A seal line 310 is formed at edges of lower and upper substrates 212 and 214 so as to combine the lower substrate 212 with the upper substrate 214.

Referring to FIGS. 3A and 3B, the lower substrate 212 includes a plurality of gate wiring lines 232 and 242, a plurality of storage electrode lines 235, a plurality of data wiring lines 234, 244, and 249, a plurality of pixel electrodes 82, common contacts 240, and a seal line 310.

The plurality of gate wiring lines 232 and 242 and the plurality of storage electrode lines 235 are connected to a gate chip film package 250, while a plurality of data wiring lines 234, 244, and 249 are connected to data chip film packages 260 and 270.

Each of the common contacts 240 transmits a common voltage from the lower substrate 212 to a common electrode 27 on the upper substrate 214. The common contact 240 has a common contact hole 247 exposing a common contact layer 241, and a common contact pad 238 patterned on the common contact hole 247. Thus, a common voltage is transmitted to the common contact layer 241 through the common electrode line 237, to then be directly transmitted to the common contact pad 238. The common contact pad 238 is separated from the common electrode 27 by a cell gap. The common contact pad 238 is connected to the common electrode 27 via a conductor 320 (to be described in more detail later) disposed within the seal line 310, so as to transmit a common voltage to the common electrode 27.

The seal line 310 is interposed between edges of the lower and upper substrates 212 and 214, so as to combine the lower substrate 212 with the upper substrate 214. The seal line 310 creates a cell gap between the lower and upper substrates 212 and 214, into which liquid crystals are injected, and also prevents leakage of the liquid crystals. The seal line 310 includes a sealant 305 having a predetermined width, a black material 330 blocking light, and conductors 320 mixed with the sealant 305.

The black material 330 may be partially incorporated in the sealant 305. The black material 310 is disposed within the seal line 310, and blocks out light passing through the sealant 310 so as to prevent leakage of light into the display area DA. For example, the black material 330 may be an opaque organic material. The organic material may be organic photosensitive resin containing carbon black particles, titanium oxide (TiOx) particles, a mixture of color pigments, or at least one of carbon black particles, TiOx particles, and color pigments.

Since the black material 330 can prevent leakage of light between the display area DA and non-display area NA, the liquid crystal panel assembly of the present embodiment eliminates the need for a separate black matrix disposed around the seal line 310 on the upper substrate 214, thereby allowing for increased display area DA. The increased display area DA may result in the reduction of both a non-display area NA and a bezel width. An area of the liquid crystal panel 210 on which an image is displayed is hereinafter referred to as a display area DA. Edges of the liquid crystal panel 210 where the seal line 310 attaches the upper substrate 214 to the lower substrate 212 are herein defined as a non-display area NA.

The conductors 320 are mixed with the sealant 305, and electrically connect the common contact 240 on the lower substrate 212 with the common electrode 27. The conductors 320 may be introduced into and applied to the sealant 305, and couple the common contacts 240 with the common electrode 27 on the upper substrate 214 through the contact hole 247. The conductors 320 may act as spacers that maintain a desired cell gap and add mechanical strength.

In this case, the conductors 320 are incorporated into the seal line 310 so as to act as a short circuit that transmits a common voltage to the common electrode 27 on the upper substrate 214. That is, the liquid crystal panel 210 includes common contacts 210 disposed within the seal line 310 for applying power to the common electrode 27 without the need for separate supply lines outside the seal line 310, thereby allowing for reduction in the size of non-display area NA.

An effective display area (DA) on the lower and upper substrates 212 and 214 has a stack structure including one or more thin films deposited thereon.

Referring to FIG. 3B, the upper substrate 214 includes a black matrix 25, a common electrode 27, and a color filter 29 formed on a second insulating substrate 20.

More specifically, the color filter 29 includes red (R), green (G), and blue (B) filters on the second insulating substrate 20 in such a way as to match corresponding pixel regions. The black matrix 25 is disposed opposite the TFT array on the lower substrate 212, and absorbs undesired light.

The common electrode 27 is formed on the second insulating layer 20 to a substantially uniform thickness. The common electrode 27 may be formed of transparent conductive materials such as Indium Tin Oxide (ITO) or Indium Zinc Oxide (IZO). The upper substrate 214 may further include an orientation layer (not shown) formed on the common electrode 27. A liquid crystal layer 90 is interposed between the lower and upper substrates 212 and 214. Orientation layers formed on the lower and upper substrate 212 and 214 cause a pretilt of liquid crystal molecules in the liquid crystal layer 90 at a predetermined angle.

Referring to FIGS. 3A and 3B, the lower substrate 212 includes gate wiring lines 232 and 242, a gate insulating layer 30, a semiconductor layer 40, resistance contact layers 55 and 56, data wiring lines 234, 244, and 249, a plurality of storage electrode lines 235, a passivation layer 70, and pixel electrodes 82 that are formed on a first insulating substrate 10. The lower substrate 212 also has TFT transistors formed on the first insulating substrate 10 using vacuum deposition. The TFT transistors act as a switch that controls the orientation of liquid crystals in response to an electrical signal.

The gate wiring lines 232 and 242 are formed on the first insulating substrate 10. Here, the gate wiring lines 232 and 242 include gate lines 232 extending on the first insulating substrate 10 in a first direction.

A gate insulating layer 30 made of an insulating material such as silicon nitride (SiNₓ) is formed on the gate wiring lines 232 and 242. A semiconductor layer 40 made of hydrogenated amorphous silicon (“a-Si”) or polysilicon is formed on the gate insulating layer 30. Ohmic contact layers 55 and 56 made of, for example, silicide or n+ amorphous silicon hydride in which an n-type impurity is highly doped, are formed on the semiconductor layer 40. The ohmic contact layers 55 and 56 improve contact characteristics between a source electrode 244 and a drain electrode 249, and the semiconductor layer 40.

The data wiring lines 234, 244, and 249 extend in a second direction, e.g., a longitudinal direction, to cross the gate wiring lines 232, and receive data signals and transmit the same to the source electrode 244.

The source electrode 244, the drain electrode 249, and the gate electrode 242 collectively form a thin film transistor 15 that acts as a switching element. When sufficient voltage is applied to the gate electrode 242, a current flows between the source electrode 244 and the drain electrode 249.

A contact hole 79 is formed in the passivation layer 70 to expose the drain electrode 249. The pixel electrode 82 is electrically connected to drain electrode 249 through the contact hole 79, and positioned at each pixel. The pixel electrode 82 may be formed of transparent conductive materials such as Indium Tin Oxide (ITO) or Indium Zinc Oxide (IZO), or an opaque conductor having desirable light-reflecting characteristics, such as Al.

FIG. 4A illustrates the arrangement of the seal line 310 and the common contacts 240 on the non-display area NA. The seal line 310 has a predetermined width, and is formed at edges of the lower and upper substrates 212 and 214 adjacent to the effective display area (DA).

The common contacts 240 are arranged at regular intervals within the seal line 310 at the edge of the lower substrate 212. Each of the common contacts 240 includes a common electrode line 237 supplying a common electrode signal received from the data drive chip 275, a common contact layer 241 connected to the common electrode line 237, a contact hole 247 formed in the passivation layer 70 overlying the common contact layer 241, and a common contact pad 238 formed on the common contact layer 241.

By introducing electric conductors 320 into the seal line 310, an electrical path can be created between the common contact pad 238 and the common electrode 27 on the upper substrate 214. Thus, a common voltage applied from the data drive chip 275 can be transmitted to the common electrode 27 via the common contact 240. Further, the common contacts 240 are disposed within the seal line 310 so as to supply a common voltage to the common electrode, thereby reducing a non-display area NA.

Referring to FIG. 4B, the seal line 310 is disposed on the non-display area NA and includes a sealant 305 having a predetermined width, a black material 330 blocking light, and conductors. The common contacts 240 are arranged on the lower substrate 212 where the seal line 310 is disposed, and apply a common power voltage or transmit a common voltage to the common electrode 27 on the upper substrate 212.

Forming the common contact 240 includes forming the common contact layer 241 on the gate insulating layer 30, forming the passivation layer 70 on the common contact layer 241, etching the passivation layer 70 so as to form the contact hole 247, and depositing the common contact pad 238 so that the conductor 320 is coupled thereto.

Then, the conductor 320 is introduced into the sealant 305 so as to electrically connect the common contact 240 on the lower substrate 212 with the common electrode 27 on the upper substrate 214. The conductor 320 may have various shapes such as a sphere, a cylinder, or a polyprism, and may be formed of metal such as gold (Au), silver (Ag), or copper (Cu). Alternatively, the conductor 320 may have a surface coated with conductive materials in order to achieve adequate conductivity. The conductor 320 may also be shaped to act as a spacer that maintains a uniform gap between the lower and upper substrates 212 and 214.

As described above, the data drive chip 275 is connected to the common electrode 27 on the upper substrate 214 via the conductor 320, so that a common electrode signal generated by the data drive chip 275 is applied to the common electrode 27.

By varying the magnitude of a common voltage applied to one or more of the common contacts 240, different common voltages can be applied locally to the common electrode 27.

According to the present embodiment, as described above, the common contacts 240 are arranged at positions where the seal line 310 is formed, and a common voltage is supplied to the common electrode 27 on the upper substrate 214 via the conductors 320. The liquid crystal panel according to the present embodiment includes common contacts 240 arranged within the seal line 310, eliminating the need for a separate region for supplying a common voltage and allowing for a reduction in the size of the non-display area NA.

Referring to FIGS. 5A and 5B, a plurality of conductors 321 and 322 may be disposed within the contact hole 247 of the common contact 240. The plurality of conductors 321 and 322 can be arranged in various ways within seal line 310 while still maintaining electrical connection between the common contact 240 and the common electrode 27. In particular, connection can be maintained even though the conductors 321 and 322 may be aligned within the seal line 310 in almost any fashion.

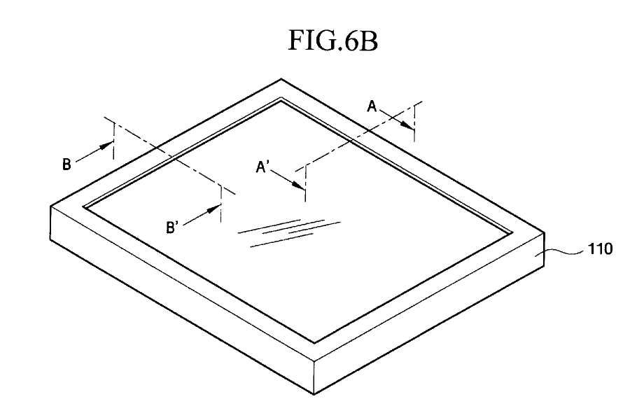

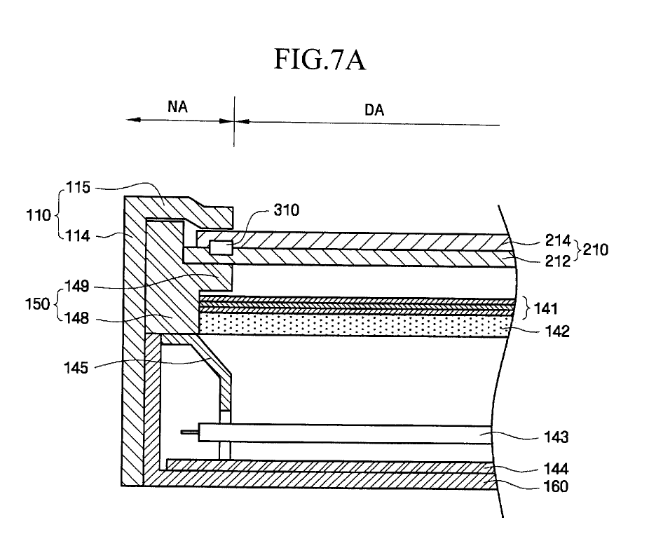

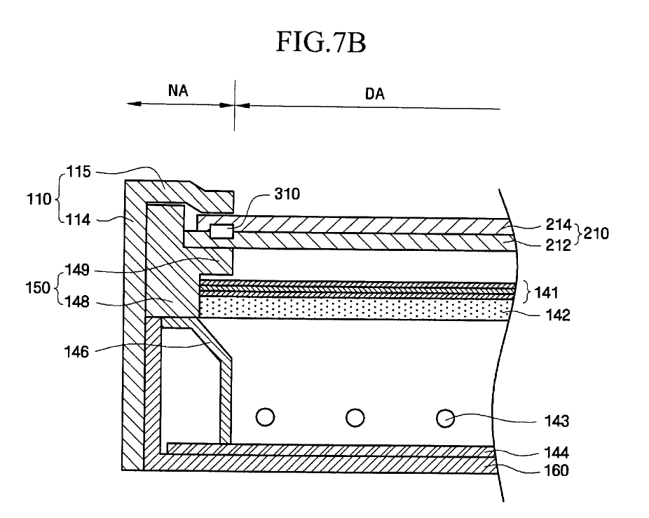

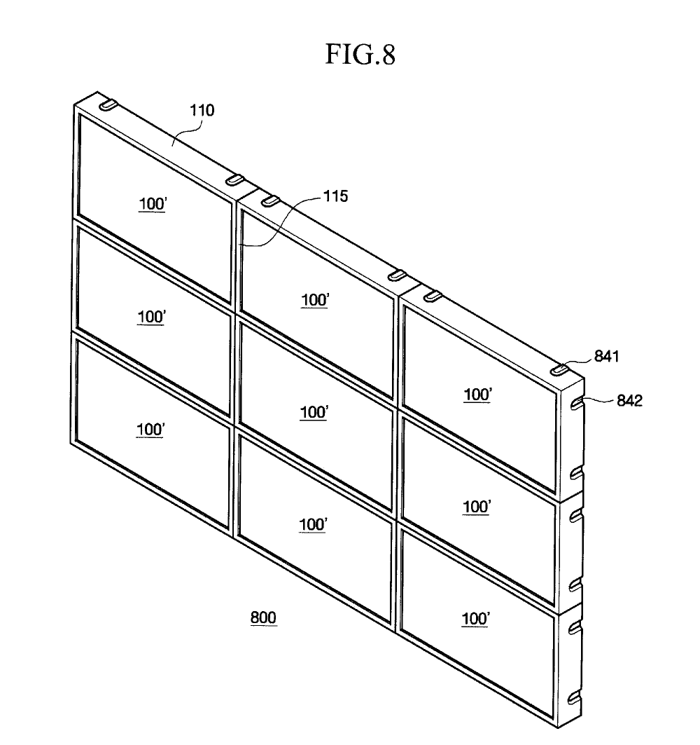

FIG. 6A is an exploded perspective view of a liquid crystal display (LCD) module 100 according to an embodiment of the present invention, and FIG. 6B is an assembled perspective view of the LCD module 100 of FIG. 6A. FIG. 7A is a cross-sectional view of the LCD module 100 taken along line B-B′ of FIG. 6B, and FIG. 7B is a cross-sectional view of the LCD module 100 taken along line A-A′ of FIG. 6B.

Referring to FIGS. 6A through 7B, the LCD module 100 according to the present embodiment includes a liquid crystal panel assembly 200, a backlight assembly 140, and a top receiving container 110.

The liquid crystal panel assembly 200 includes a liquid crystal panel 210 having a lower substrate 212, an upper substrate 214, and a liquid crystal layer (not shown) sandwiched therebetween, first flexible films 250, second flexible films 260 and 270, and first and second PCBs 220 and 225.

The backlight assembly 140 includes a plurality of optical sheets 141, a diffusion plate 142, a lamp 143, and a reflection sheet 144.

The lamp 143 is a light source that provides the liquid crystal panel 210 with light. The lamp 143 may, for example, be a cold cathode fluorescent lamp (CCFL), a hot cathode fluorescent lamp (HCFL), or an external electrode fluorescent lamp (EEFL). A point light source such as a light emitting diode (LED) or a surface light source such as a flat fluorescent lamp (FFL) can also be used in place of the lamp 143 of the current embodiment. Here, an LED light source is used as an example, and a plurality of LEDs arranged in parallel with each other are illustrated.

The diffusion plate 142 may be disposed above the lamp 143 to improve uniformity in the brightness of light generated by lamp 143. The reflection sheet 144 is disposed below the lamp 143 and reflects light upward. The reflection sheet 144 may be integrally formed on the bottom surface of a bottom receiving container 160. Reflecting covers 145 and 146 (for covering one end of the lamp 143 or reflecting light upward) may be further provided at edges of the bottom receiving container 160.

The plurality of optical sheets 141 may include diffusion sheet 142 and first and second prism sheets.

The backlight assembly 140 further includes a receiving frame 150 and the bottom receiving container 160, which receive the optical sheets 141, the diffusion plate 142, the lamp 143, and the reflection sheet 144.

The liquid crystal panel 210 is disposed on the optical sheets 141, supported by the receiving frame 150, and seated into the bottom receiving containing 160.

The receiving frame 150 has sidewalls 148 extending along edges of a rectangular shape and has a stepped portion or protrusion formed on the inside thereof so as to support the liquid crystal panel 210.

The bottom receiving container 160 includes a rectangular bottom surface and sidewalls extending from edges of the bottom surface, and holds the optical sheets 141, the diffusion plate 142, the lamp 143, the reflection sheet 144, and the liquid crystal panel 210 in place.

The top receiving container 110 is combined with the receiving frame 150 and/or the bottom receiving container 160 to protect and hold in place the liquid crystal panel assembly 200 and the backlight assembly 140. The top receiving container 110 may be combined with the bottom receiving container 160 by, for example, a hook (not shown) and/or screw (not shown) connection method.

A cross-sectional structure of the LCD module 100 according to the present embodiment is described in more detail with reference to FIGS. 7A and 7B.

Referring to FIGS. 7A and 7B, the top receiving container 110, the liquid crystal panel assembly 200, the receiving frame 150, the optical sheets 141, and a light guide panel (LGP) are sequentially stacked on a non-display area NA.

The top receiving container 110 includes a sidewall portion forming four sides, and a bezel 115 extending inward from the sidewall portion 114. The sidewall portion 114 encloses the non-display area NA of the liquid crystal panel 210, and has a central window exposing the display area DA. The bezel 115 has sufficient width to extend to the inner wall of the seal line 310 in the liquid crystal panel assembly 200. More specifically, the top receiving container 110 includes a window exposing the display area DA, and the bezel 115 covering the non-display area NA disposed outside this window. That is, the bezel 115 covers the non-display area NA of the liquid crystal panel 210 from the outer perimeter of the liquid crystal panel 210 to the inside of the seal line 310.

The liquid crystal panel assembly 200 is fitted into the recess formed by the bezel 115 and the protrusion 149. The protrusion 149 extends inward to the inside of (i.e., an inner surface of) the seal line 310.

The plurality of optical sheets 141 and the LGP 142 are disposed under the protrusion 149 of the receiving frame 150 and supported by the bottom receiving container 160 or the receiving frame 150 An edge of the LGP 142 securely seated into the bottom receiving container 160 or the receiving frame 150. The edge of the LGP 142 is located at the same position as or outside an area on which the seal line 310 is located. Light emitted from the lamp 143 is provided to the display area DA via the LGP 142 and the optical sheets 141.

Alternatively, the edge of the receiving frame 150 or the bottom receiving container 160 may be disposed in close proximity to the seal line 310. Since the seal line 310 is located at a portion of the non-display area NA closest to the display area DA, the width of the non-display area NA may reduce.

Hereinafter, a multi-display apparatus including a plurality of display units is described in detail with reference to FIG. 8. FIG. 8 is a perspective view of a multi-display apparatus 800 according to an embodiment of the present invention.

The multi-display apparatus 800 includes a plurality of display units 100′ and a fixing unit connecting the plurality of display units 100 with each other in such a way as to form a matrix. The multi-display apparatus 800 also includes a controller (not shown) that allows multiple screens on the plurality of display units 100′ to form a single large, multi-display screen.

The multi-display apparatus 800 can adjust a screen ratio according to the number of display units 100′ combined, and manner in which they are arranged. That is, by adjusting the number of display units 100′ arranged in columns to be equal to the number of display units 100′ arranged in rows, the screen ratio of the multi-display apparatus 800 can be same as the screen ratio of the display unit 100′. The screen ratio of the multi-display apparatus 800 can also be adjusted according to its use and place of display.

The multi-display apparatus 800 may not be necessarily controlled to display a single screen. That is, some of the display units 100′ can display a first image while others can display a second image.

Here, the display units 100′ in the multi-display apparatus 800 are arranged to form a flat display where each display unit 100′ is brought into contact with adjacent display units 100′ by a fixing unit. More specifically, each display unit 100′ has fitting protrusions 841 and fitting recesses 842 on an outer surface of their receiving containers 110. The fitting protrusions 841 and the fitting recesses 842 allow the display units 100′ to be fitted together to form a single multi-display apparatus 800.

Like the LCD module 100 of FIG. 6A, each display unit 100′ includes a liquid crystal panel assembly 200, a backlight assembly 140, and a top receiving container 110. The liquid crystal panel 210 in each display unit 100′ includes a seal line 310 having conductors 320 and common contacts 240 contained therein. Thus, a non-display area NA in each display unit 100′, as well as a bezel width, can be reduced. Accordingly, in displays such as the multi-display apparatus 800 where multiple display units 100′ are arranged in a matrix, areas between images can be reduced, thereby providing a more seamless image.

In the liquid crystal panel 210 of each display unit 100′, a plurality of gate lines 232 and a plurality of storage electrode lines 235 are connected directly to a gate drive chip 255. Thus, the gate drive chip 255 delivers a gate signal and a storage electrode signal to the plurality of gate lines 232 and the plurality of storage electrode lines 235, respectively. In this manner, the display unit 100′ according to the present embodiment eliminates the need for a separate contact hole or connection line for applying signals to the plurality of storage electrode lines 235, thereby reducing the size of non-display area NA. Thus, a bezel width in each display unit 100′ can be reduced, reducing the space between screens of the multi-display apparatus 800 and improving the quality of the image displayed.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A display apparatus comprising:
a first insulating substrate;
a plurality of gate lines and a plurality of data lines on the first insulating substrate, the plurality of gate lines arranged to intersect the plurality of data lines;
a plurality of storage electrode lines arranged substantially parallel to the plurality of gate lines; and
a gate drive chip electrically connected to the plurality of gate lines and the plurality of storage electrode lines, the gate drive chip configured to apply a gate voltage to the gate lines and a storage voltage to the storage electrode lines.

2. The display apparatus of claim 1, further comprising a flexible film connected to ends of the gate lines and the storage electrode lines, wherein the gate drive chip is mounted on the flexible film.

3. The display apparatus of claim 2, further comprising a PCB (Printed Circuit Board) electrically connected to the plurality of gate lines and the plurality of storage electrode lines by the flexible film.

4. The display apparatus of claim 1, further comprising a second insulating substrate opposing the first insulating substrate, a seal line interposed between edges of the first and second insulating substrates so as to combine the first and second insulating substrates, and a conductor mixed with the seal line so as to conduct electricity between the first and second insulating substrates.

5. The display apparatus of claim 4, wherein the seal line further includes a black material.

6. The display apparatus of claim 4, wherein the first insulating substrate further includes a common contact that overlaps the seal line and is connected to the conductor to which a common power voltage is applied.

7. The display apparatus of claim 4, further comprising a receiving container receiving the first and the second insulating substrates, the receiving container comprising:
a sidewall portion formed along sides of the first and second insulating substrates; and
a bezel extending from the sidewall portion to an inner surface of the seal line and overlapping the first and second insulating substrates.

8. The display apparatus of claim 7, further comprising a receiving frame that has a recess into which the first insulating substrate is seated, and a protrusion that is aligned with the inner surface of the seal line.

9. The display apparatus of claim 1, wherein the gate lines are arranged in alternating manner with the storage electrode lines.

10. The display apparatus of claim 1, wherein each of the plurality of storage electrode lines is directly connected to the gate drive chip.

11. A multi-display apparatus comprising:
a plurality of display units, each display unit including a first insulating substrate, a plurality of gate lines and a plurality of data lines arranged to intersect one another on the first insulating substrate, a plurality of storage electrode lines arranged substantially parallel to the plurality of gate lines, and a gate drive chip electrically connected to the plurality of gate lines and the plurality of storage electrode lines, the gate drive chip configured to apply a gate voltage to the gate lines and a storage voltage to the storage electrode lines, and
a fixing unit combining the plurality of display units to form a matrix.

12. The multi-display apparatus of claim 11, further comprising a flexible film connected to ends of the gate lines and the storage electrode lines, wherein the gate drive chip is mounted on the flexible film.

13. The multi-display apparatus of claim 12, further comprising a PCB (Printed Circuit Board) electrically connected to the plurality of gate lines and the plurality of storage electrode lines by the flexible film.

14. The multi-display apparatus of claim 11, further comprising a second insulating substrate opposing the first insulating substrate, a seal line interposed between edges of the first and second insulating substrates so as to combine the first and second insulating substrates, and a conductor mixed with the seal line so as to conduct electricity between the first and second insulating substrates.

15. The multi-display apparatus of claim 14, wherein the seal line further includes a black material.

16. The multi-display apparatus of claim 14, wherein the first insulating substrate further includes a common contact that overlaps the seal line and is connected to the conductor to which a common power voltage is applied.

17. The multi-display apparatus of claim 14, further comprising a receiving container receiving the first and the second insulating substrates, the receiving container comprising:
a sidewall portion formed along sides of the first and second insulating substrates; and
a bezel extending from the sidewall portion to an inner surface of the seal line and overlapping the first and second insulating substrates.

18. The multi-display apparatus of claim 17, further comprising a receiving frame that has a recess into which the first insulating substrate is seated, and a protrusion that is aligned with the inner surface of the seal line.

19. The multi-display apparatus of claim 11, wherein the gate lines are arranged in alternating manner with the storage electrode lines.

20. The multi-display apparatus of claim 11, wherein each of the plurality of storage electrode lines is directly connected to the gate drive chip.
